(19) United States
(12) Patent Application Publication
(10) Pub. No.: US 2019/0092978 A1
(43) Pub. Date: Mar. 28, 2019

(54) ADHESIVE SHEET FOR MOLDING STAGE

(71) Applicant: NITTO DENKO CORPORATION, Ibaraki-shi, Osaka (JP)

(72) Inventors: Yoshiko OGINO, Ibaraki-shi (JP); Yutaka TOSAKI, Ibaraki-shi (JP); Michiro KAWANISHI, Ibaraki-shi (JP)

(73) Assignee: NITTO DENKO CORPORATION, Ibaraki-shi, Osaka (JP)

(21) Appl. No.: 16/082,602

(22) PCT Filed: Feb. 28, 2017
(86) PCT No.: PCT/JP2017/007778

§ 371 Date: Sep. 6, 2018

(30) Foreign Application Priority Data
Mar. 17, 2016 (JP) 2016-053220

(51) Int. Cl. C09J 7/38; C09J 7/21; C09J 7/25; C09J 7/24

(52) U.S. Cl. CPC C09J 7/383; C09J 2407/00; C09J 7/21; C09J 7/25; C09J 7/255; C09J 7/241; C09J 7/245; C09J 2400/283; C09J 2400/263; C09J 2423/006; C09J 2467/006; C09J 2479/086; C09J 2477/006; C09J 2427/006; C09J 2431/006; C09J 2205/114; C09J 2433/00; C09J 7/385

(57) ABSTRACT

A pressure-sensitive adhesive sheet (X1), which is a pressure-sensitive adhesive sheet for build stage use according to the present invention, has a multilayer structure typically including a substrate (11) and a pressure-sensitive adhesive layer (12). The pressure-sensitive adhesive sheet (X1) has a puncture strength of 3.3 to 12 N, where the puncture strength is determined as a maximum load during a process in which a probe having a hemispherical head with the radius of curvature of 0.5 mm pierces the pressure-sensitive adhesive sheet at a travel speed of 0.2 mm/s. The pressure-sensitive adhesive sheet for build stage use is suitable for detachment of an object, which is formed on a build stage typically of an additive manufacturing apparatus, from the build stage while less causing the significant damage to the object.

### TECHNICAL FIELD

The present invention relates to technologies for the attachment and detachment between a build stage (molding stage) typically of an additive manufacturing apparatus and an object to be formed on or over the build stage.

### BACKGROUND ART

Additive manufacturing apparatuses, which are also called as 3D printers, have been developed more and more. The additive manufacturing apparatuses include a build stage on which a three-dimensional object is to be formed. In the additive manufacturing apparatuses, an object is formed on such a build stage by a so-called additive manufacturing technique such as fused deposition modeling (fused filament fabrication), material jetting, stereolithography (vat polymerization), powder bed fusion, binder jetting, or sheet lamination. The additive manufacturing apparatuses as above are described typically in Patent Literature (PTL) 1 to 4 as follows.

### CITATION LIST

### Patent Literature

PTL 1: Japanese Unexamined Patent Application Publication (JP-A) No. H09-24552

PTL 2: JP-A No. 2011-101834

PTL 3: JP-A No. 2015-212042

PTL 4: JP-A No. 2016-5869

### SUMMARY OF INVENTION

### Technical Problem

An object during its formation may be attached onto a build stage in a process of forming the object on the build stage, in some manufacturing techniques employed in additive manufacturing apparatuses. In this case, the object has to be detached or separated from the build stage after the completion of the object forming process on the build stage. In a technique often employed for the detachment, a scraper or another tool having a sharp edge is pushed in between the build stage and the object attached onto the build stage, to separate the build stage and the object from each other.

However, the technique as above tends to cause damage and fracture of the object by the tool having a sharp edge, such as a scraper, because the object is often acted upon by relatively large force through the tool.

The present invention has been made under these circumstances and has an object to provide a pressure-sensitive adhesive sheet for build stage use which is suitable for the removal of an object from a build stage of an additive manufacturing apparatus or another apparatus, while less causing significant damage to the object, where the object is to be formed over the build stage and may be attached onto the build stage.

### Solution to Problem

The present invention provides, in a first aspect, a pressure-sensitive adhesive sheet for build stage use. This pressure-sensitive adhesive sheet is to be used by affixing the same to an object-forming surface of a build stage of an additive manufacturing apparatus or another apparatus. The pressure-sensitive adhesive sheet has a multilayer structure including a substrate and a pressure-sensitive adhesive layer. The pressure-sensitive adhesive sheet has a puncture strength of 3.3 to 12 N, where the puncture strength is determined as a maximum load during a process in which a probe having a hemispherical head with the radius of curvature of 0.5 mm pierces the pressure-sensitive adhesive sheet at a travel speed of 0.2 mm/s. The pressure-sensitive adhesive sheet for build stage use according to the aspect may be a so-called single-sided pressure-sensitive adhesive sheet or a so-called double-sided pressure-sensitive adhesive sheet. The pressure-sensitive adhesive sheet for build stage use may be in the form typically of a pressure-sensitive adhesive tape which is rolled.

Specifically, the pressure-sensitive adhesive sheet for build stage use may be used typically by a procedure as follows. Initially, the pressure-sensitive adhesive sheet for build stage use is affixed, through the pressure-sensitive adhesive layer thereof, to an object-forming surface of a build stage of an additive manufacturing apparatus or another apparatus for the formation of an object. In operation of the apparatus, the target object is gradually built up or formed, through a predetermined process, on the pressure-sensitive adhesive sheet disposed on the object-forming surface of the build stage. In the process of forming the object over the build stage, the pressure-sensitive adhesive sheet for build stage use adheres onto the build stage, and the object during its formation is attached onto the pressure-sensitive adhesive sheet for build stage use disposed on the build stage. After the completion of the object forming process over the build stage, an operation of removing the pressure-sensitive adhesive sheet for build stage use from the object-forming surface of the build stage is performed. This allows the pressure-sensitive adhesive sheet for build stage use to be removed from the surface of the build stage and allows the object to be detached from the build stage.

The pressure-sensitive adhesive sheet for build stage use has a rupture strength of 3.3 N or more, where the rupture strength is determined as above. This configuration is suitable for allowing the pressure-sensitive adhesive sheet for build stage use to keep from or resist rupturing during the removing operation. In some designs, the object to be formed over the build stage has a sharp portion and/or a protruded portion at an end facing the build stage; and, in the removing operation, the sharp portion and/or the protruded portion of the object may bump against the pressure-sensitive adhesive sheet for build stage use during pulling away and removing of the pressure-sensitive adhesive sheet from the build stage. For example in such a case, the configuration, where the pressure-sensitive adhesive sheet for build stage use has a puncture strength of 3.3 N or more as determined by the procedure, is suitable for allowing the pressure-sensitive adhesive sheet for build stage use to keep from or resist rupturing. The rupture of the pressure-sensitive adhesive sheet for build stage use, if occurring in the removing operation, may require scraper or another tool to detach the object from the build stage.

The pressure-sensitive adhesive sheet for build stage use has a puncture strength of 12 N or less as determined by the procedure. This configuration is suitable for allowing the pressure-sensitive adhesive sheet for build stage use to keep from having excessive stiffness (rigidity) and to surely have easiness to deform (good deformability), where such good deformability is required in the removing operation.

As described above, the pressure-sensitive adhesive sheet for build stage use according to the first aspect of the present invention is suitable for surely offering good deformability required in a removing operation from the build stage, while keeping from or resisting rupturing in the removing operation. The pressure-sensitive adhesive sheet for build stage use as above, when used in the above manner for the formation of an object typically by an additive manufacturing apparatus, can dispense with or minimize the use of a scraper or another tool having a sharp edge to detach the object from the build stage. Accordingly, the pressure-sensitive adhesive sheet for build stage use is suitable for detaching an object formed over a build stage of an additive manufacturing apparatus or another apparatus, while less causing significant damage to the object. The pressure-sensitive adhesive sheet for build stage use, which can dispense with or minimize the use of a scraper or another tool having a sharp edge to detach the object from the build stage, is also advantageous for less causing damage to the build stage upon detachment of the object.

The present invention provides, according to a second aspect, a pressure-sensitive adhesive sheet for build stage use which is used by affixing the same to an object-forming surface of a build stage of an additive manufacturing apparatus or another apparatus. The pressure-sensitive adhesive sheet has a multilayer structure including a first pressure-sensitive adhesive layer, a second pressure-sensitive adhesive layer, and a substrate disposed between the first and second pressure-sensitive adhesive layers. The pressure-sensitive adhesive sheet for build stage use has a puncture strength of 3.3 to 12 N, where the puncture strength is determined as a maximum load during a process in which a probe having a hemispherical head with the radius of curvature of 0.5 mm pierces the pressure-sensitive adhesive sheet at a travel speed of 0.2 mm/s. The pressure-sensitive adhesive sheet for build stage use may be in the form typically of a pressure-sensitive adhesive tape which is rolled.

Specifically, the pressure-sensitive adhesive sheet for build stage use may be used typically by a procedure as follows. Initially, the pressure-sensitive adhesive sheet for build stage use is affixed, typically through the first pressure-sensitive adhesive layer, to an object-forming surface of a build stage of an additive manufacturing apparatus or another apparatus for the formation of an object. In operation of the apparatus, the target object is gradually built up or formed, through a predetermined process, on the pressure-sensitive adhesive sheet disposed on the object-forming surface of the build stage. In the process of forming the object over the build stage, the pressure-sensitive adhesive sheet for build stage use adheres, at the first pressure-sensitive adhesive layer, onto the build stage, and the object during its formation is attached to the surface defined by the second pressure-sensitive adhesive layer of the pressure-sensitive adhesive sheet on the build stage. After the completion of the object forming process over the build stage, a removing operation of the pressure-sensitive adhesive sheet for build stage use from the object-forming surface of the build stage is performed. This allows the pressure-sensitive adhesive sheet for build stage use to be removed from the surface of the build stage and allows the object to be detached from the build stage.

The pressure-sensitive adhesive sheet for build stage use has a puncture strength of 3.3 N or more as determined by the procedure. This configuration is suitable for allowing the pressure-sensitive adhesive sheet for build stage use to keep from rupturing during the removing operation. In the removing operation, a sharp portion and/or a protruded portion of the object may bump against the pressure-sensitive adhesive sheet for build stage use during pulling away and removing of the pressure-sensitive adhesive sheet from the build stage. For example in such a case, the configuration, where the pressure-sensitive adhesive sheet for build stage use has a puncture strength of 3.3 N or more as determined by the procedure, is suitable for allowing the pressure-sensitive adhesive sheet for build stage use to keep from or resist rupturing. The rupture of the pressure-sensitive adhesive sheet for build stage use, if occurring in the removing operation, may require a tool such as a scraper to detach the object from the build stage.

The pressure-sensitive adhesive sheet for build stage use has a puncture strength of 12 N or less as determined by the procedure. This configuration is suitable for allowing the pressure-sensitive adhesive sheet for build stage use to keep from having excessive stiffness (rigidity) and to surely offer good deformability, where such good deformability is required in the removing operation.

As described above, the pressure-sensitive adhesive sheet for build stage use according to the second aspect of the present invention is suitable for surely offering good deformability required in a removing operation from the build stage, while keeping from or resisting rupturing during the removing operation. The pressure-sensitive adhesive sheet for build stage use as above, when used in the above manner for the formation of an object typically by an additive manufacturing apparatus, can dispense with or minimize the use of a scraper or another tool having a sharp edge to detach the object from the build stage. Accordingly, the pressure-sensitive adhesive sheet for build stage use is suitable for detaching an object formed over a build stage of an additive manufacturing apparatus or another apparatus, while less causing significant damage to the object. The pressure-sensitive adhesive sheet for build stage use, which can dispense with or minimize the use of a scraper or another tool having a sharp edge to detach the object from the build stage, is also advantageous for less causing damage to the build stage upon detachment of the object.

The pressure-sensitive adhesive sheets for build stage use according to the first and second aspects of the present invention preferably each have a fracture energy of 0.24 to 4 N·m, where the fracture energy is energy necessary to cause rupture of the pressure-sensitive adhesive sheet in a tensile break test performed at a sample width of 18 mm, a gripping distance of 125 mm, and a tensile speed of 300 mm/min. The fracture energy of a pressure-sensitive adhesive sheet may serve as an index for toughness of the pressure-sensitive adhesive sheet. The configuration, where the pressure-sensitive adhesive sheet for build stage use has a fracture energy of 0.24 N·m or more as determined by the procedure, is advantageous for allowing the pressure-sensitive adhesive sheet for build stage use to actually have sufficient toughness or strength so as to resist rupturing. The configuration, where the pressure-sensitive adhesive sheet for build stage use has a fracture energy of 4 N·m or less as determined by the procedure, is advantageous for allowing the pressure-sensitive adhesive sheet for build stage use to surely offer good deformability during the removing operation, while surely having toughness or strength.

The pressure-sensitive adhesive sheets for build stage use according to the first and second aspects of the present invention each have a tensile strain at break of preferably 4% to 50%. The configuration, where the pressure-sensitive adhesive sheets for build stage use have a tensile strain at break, namely, a breaking elongation of 4% or more, is advantageous for dispersing stress at a site where the object or a portion thereof, such as a sharp portion and/or a protruded portion, bumps against the pressure-sensitive adhesive sheet for build stage use during pulling away and removing of the pressure-sensitive adhesive sheet from the build stage. The stress dispersion as above contributes to allowing the pressure-sensitive adhesive sheets for build stage use to resist rupturing during the removing operation. In addition, the stress dispersion also contributes to less causing significant damage to the object during the removing operation. In contrast, the configuration, where the pressure-sensitive adhesive sheets for build stage use have a tensile strain at break, namely, a breaking elongation of 50% or less, is advantageous for allowing the pressure-sensitive adhesive sheets for build stage use to surely have sufficient strength to resist rupturing.

The pressure-sensitive adhesive sheet for build stage use according to the first aspect of the present invention preferably has a 90-degree peel strength from an acrylic plane of 0.5 to 15 N/18 mm, where the 90-degree peel strength is measured at a peel temperature of 23° C. and a tensile speed of 300 mm/min. As used herein, the term “acrylic plane” refers to a plane of an acrylic resin member, such as an acrylic resin plate, containing an acrylic resin in a content of 95 mass percent or more. The pressure-sensitive adhesive sheet for build stage use according to the second aspect of the present invention preferably has a 90-degree peel strength from an acrylic plane of 0.5 to 15 N/18 mm in at least one of the first pressure-sensitive adhesive layer and the second pressure-sensitive adhesive layer, where the 90-degree peel strength is measured at a peel temperature of 23° C. and a tensile speed of 300 mm/min. Some additive manufacturing apparatuses include a build stage that is made from an acrylic resin in at least the object-forming surface. The configuration, where the pressure-sensitive adhesive sheets have a 90-degree peel strength of 0.5 N/18 mm or more as determined by the procedure, is advantageous for allowing the pressure-sensitive adhesive sheets for build stage use to resist separation and gap (lifting) from the build stage surface during object formation, and, consequently, is advantageous for allowing the object during its formation to resist displacement (misregistration) on the pressure-sensitive adhesive sheets for build stage use. The configuration, where the pressure-sensitive adhesive sheets have a 90-degree peel strength of 15 N/18 mm or less as determined by the procedure, is advantageous for allowing the pressure-sensitive adhesive sheets for build stage use to surely have good removability from a build stage made from an acrylic resin in at least the object-forming surface. In addition, the configuration, where the pressure-sensitive adhesive sheets have a 90-degree peel strength of 15 N/18 mm or less as determined by the procedure, is also advantageous for allowing the pressure-sensitive adhesive sheets for build stage use to less leave adhesive residue on a build stage upon removal from the build stage, where the build stage is made from an acrylic resin in at least the object-forming surface.

The pressure-sensitive adhesive sheet for build stage use according to the first aspect of the present invention preferably has a 90-degree peel strength from an aluminum plane of 0.5 to 15 N/18 mm, where the 90-degree peel strength is measured at a peel temperature of 23° C. and a tensile speed of 300 mm/min. The pressure-sensitive adhesive sheet for build stage use according to the second aspect of the present invention preferably has a 90-degree peel strength from an aluminum plane of 0.5 to 15 N/18 mm in at least one of the first pressure-sensitive layer and the second pressure-sensitive layer, where the 90-degree peel strength is measured at a peel temperature of 23° C. and a tensile speed of 300 mm/min. Some additive manufacturing apparatuses include a build stage that is made of aluminum in at least the object-forming surface. The configuration, where the pressure-sensitive adhesive sheets have a 90-degree peel strength of 0.5 N/18 mm or more as determined by the procedure, is advantageous for allowing the pressure-sensitive adhesive sheets for build stage use to resist separation and gap (lifting) from the build stage surface during the object formation and, consequently, is advantageous for allowing the object during its formation to resist displacement on the pressure-sensitive adhesive sheets for build stage use. The configuration, where the pressure-sensitive adhesive sheets have a 90-degree peel strength of 15 N/18 mm or less as determined by the procedure, is advantageous for allowing the pressure-sensitive adhesive sheets for build stage use to surely have good removability from a build stage made of aluminum in at least the object-forming surface. In addition, the configuration, where the pressure-sensitive adhesive sheets have a 90-degree peel strength of 15 N/18 mm or less as determined by the procedure, is also advantageous for allowing the pressure-sensitive adhesive sheets for build stage use to less leave adhesive residue on a build stage upon removal from the build stage, where the build stage is made of aluminum in at least the object-forming surface.

The pressure-sensitive adhesive sheet for build stage use according to the first aspect of the present invention preferably has a 90-degree peel strength from an aluminum plane of 0.5 to 15 N/18 mm, where the 90-degree peel strength is measured at a peel temperature of 23° C. and a tensile speed of 300 mm/min after the pressure-sensitive adhesive sheet undergoes lamination onto the aluminum plane, subsequent heat treatment at 100° C. for 24 hours, and subsequent cooling down. The pressure-sensitive adhesive sheet for build stage use according to the second aspect of the present invention preferably has a 90-degree peel strength from an aluminum plane of 0.5 to 15 N/18 mm in at least one of the first pressure-sensitive adhesive layer and the second pressure-sensitive adhesive layer, where the 90-degree peel strength is measured at a peel temperature of 23° C. and a tensile speed of 300 mm/min after the pressure-sensitive adhesive sheet undergoes lamination onto the aluminum plane, subsequent heat treatment at 100° C. for 24 hours, and subsequent cooling down. Some additive manufacturing apparatuses include a build stage that is made of aluminum in at least the object-forming surface and has a heating function. The configuration, where the pressure-sensitive adhesive sheets have a 90-degree peel strength of 0.5 N/18 mm or more as determined by the procedure, is advantageous for allowing the pressure-sensitive adhesive sheets for build stage use to resist separation and gap (lifting) from the surface of the build stage having a heating function during the object formation and, consequently, is advantageous for allowing the object during its formation to resist displacement on the pressure-sensitive adhesive sheets for build stage use. The configuration, where the pressure-sensitive adhesive sheets have a 90-degree peel strength of 15 N/18 mm or less as determined by the procedure, is advantageous for allowing the pressure-sensitive adhesive sheets for build stage use to surely have good removability from a build stage that is made of aluminum in at least the object-forming surface and has a heating function. In addition, the configuration, where the pressure-sensitive adhesive sheets have a 90-degree peel strength of 15 N/18 mm or less as determined by the procedure, is advantageous for allowing the pressure-sensitive adhesive sheets for build stage use to less leave adhesive residue on a build stage upon removal from the build stage, where the build stage is made of aluminum in at least the object-forming surface and has a heating function.

The pressure-sensitive adhesive sheet for build stage use according to the first aspect of the present invention preferably has a 90-degree peel strength from a polyimide plane of 0.5 to 15 N/18 mm, where the 90-degree peel strength is measured at a peel temperature of 23° C. and a tensile speed of 300 mm/min. As used herein, the term “polyimide plane” refers to a plane of a polyimide resin member, such as a polyimide resin sheet or a polyimide substrate for pressure-sensitive adhesive tapes, containing a polyimide resin in a content of 95 mass percent or more. The pressure-sensitive adhesive sheet for build stage use according to the second aspect of the present invention preferably has a 90-degree peel strength from a polyimide plane of 0.5 to 15 N/18 mm in at least one of the first pressure-sensitive adhesive layer and the second pressure-sensitive adhesive layer, where the 90-degree peel strength is measured at a peel temperature of 23° C. and a tensile speed of 300 mm/min. Some additive manufacturing apparatuses are used after a polyimide sheet is laminated onto the object-forming surface of the build stage. The configuration, where the pressure-sensitive adhesive sheets have a 90-degree peel strength of 0.5 N/18 mm or more as determined by the procedure, is advantageous for allowing the pressure-sensitive adhesive sheets for build stage use to resist separation and gap from the build stage surface during the object formation and, consequently, is advantageous for allowing the object during its formation to resist displacement on the pressure-sensitive adhesive sheets for build stage use. The configuration, where the pressure-sensitive adhesive sheets have a 90-degree peel strength of 15 N/18 mm or less as determined by the procedure, is advantageous for allowing the pressure-sensitive adhesive sheets for build stage use to surely have good removability from a build stage bearing a polyimide sheet laminated on the object-forming surface. In addition, the configuration, where the pressure-sensitive adhesive sheets have a 90-degree peel strength of 15 N/18 mm or less as determined by the procedure, is also advantageous for allowing the pressure-sensitive adhesive sheets for build stage use to less leave adhesive residue on such a build stage bearing a polyimide sheet laminated on the object-forming surface, upon removal from the build stage.

The pressure-sensitive adhesive sheet for build stage use according to the first aspect of the present invention preferably has a 90-degree peel strength from a polyimide plane of 0.5 to 15 N/18 mm, where the 90-degree peel strength is measured at a peel temperature of 23° C. and a tensile speed of 300 mm/min after the pressure-sensitive adhesive sheet undergoes lamination onto the polyimide plane, subsequent heat treatment at 100° C. for 24 hours, and subsequent cooling down. The pressure-sensitive adhesive sheet for build stage use according to the second aspect of the present invention preferably has a 90-degree peel strength from a polyimide plane of 0.5 to 15 N/18 mm in at least one of the first pressure-sensitive adhesive layer and the second pressure-sensitive adhesive layer, where the 90-degree peel strength is measured at a peel temperature of 23° C. and a tensile speed of 300 mm/min after the pressure-sensitive adhesive sheet undergoes lamination onto the polyimide plane, subsequent heat treatment at 100° C. for 24 hours, and subsequent cooling down. Some additive manufacturing apparatuses are used after a polyimide sheet is laminated onto the object-forming surface of a build stage that has a heating function. The configuration, where the pressure-sensitive adhesive sheets have a 90-degree peel strength of 0.5 N/18 mm or more as determined by the procedure, is advantageous for allowing pressure-sensitive adhesive sheets for build stage use to resist separation and gap from the surface of the build stage having the heating function during the object formation and, consequently, is advantageous for allowing the object during its formation to resist displacement on the pressure-sensitive adhesive sheets for build stage use. The configuration, where the pressure-sensitive adhesive sheets have a 90-degree peel strength of 15 N/18 mm or less as determined by the procedure, is advantageous for allowing the pressure-sensitive adhesive sheets for build stage use to surely have good removability from such a build stage bearing a polyimide sheet laminated on the object-forming surface. In addition, the configuration, where the pressure-sensitive adhesive sheets have a 90-degree peel strength of 15 N/18 mm or less as determined by the procedure, is also advantageous for allowing the pressure-sensitive adhesive sheets for build stage use to less leave adhesive residue on a build stage bearing a polyimide sheet on the object-forming surface and having a heating function, upon removal from the build stage.

In a preferred embodiment according to the first and second aspects of the present invention, the substrate includes a paper substrate. The paper substrate preferably includes at least one selected from the group consisting of Japanese paper, crepe paper, kraft paper, glassine paper, and synthetic paper. In another preferred embodiment according to the first and second aspects of the present invention, the substrate includes a nonwoven fabric substrate. The nonwoven fabric substrate preferably includes at least one selected from the group consisting of pulp, rayon, acetate fibers, polyester fibers, polyamide fibers, polyolefin fibers, and poly(vinyl alcohol) fibers. Such a pulp for the nonwoven fabric substrate preferably includes at least one selected from the group consisting of hemp pulp and wood pulp. In another preferred embodiment according to the first and second aspects of the present invention, the substrate includes a plastic substrate. The plastic substrate preferably includes at least one selected from the group consisting of a polyolefin film, a polyester film, a polyimide resin film, a polyamide resin film, a vinyl chloride resin film, and a vinyl acetate resin film.

In an embodiment according to the first and second aspects of the present invention, the pressure-sensitive adhesive layer(s) preferably includes one selected from an acrylic pressure-sensitive adhesive, a rubber pressure-sensitive adhesive, and a silicone pressure-sensitive adhesive. When the pressure-sensitive adhesive layer includes an acrylic pressure-sensitive adhesive, the acrylic pressure-sensitive adhesive preferably includes an acrylic polymer including 50 mass percent or more of a monomer unit derived from an alkyl (meth)acrylate. The alkyl (meth)acrylate preferably includes at least one selected from the group consisting of n-butyl acrylate, 2-ethylhexyl acrylate, and methyl methacrylate. When the pressure-sensitive adhesive layer(s) includes a rubber pressure-sensitive adhesive, the rubber pressure-sensitive adhesive preferably includes at least one selected from the group consisting of natural rubbers and synthetic rubbers.

### BRIEF DESCRIPTION OF DRAWINGS

FIG. 1 is a local sectional view of a pressure-sensitive adhesive sheet for build stage use according to one embodiment of the present invention;

FIGS. 2(a), 2(b), and 2(c) illustrate how to use a pressure-sensitive adhesive sheet for build stage use according to an embodiment of the present invention, in which FIGS. 2(a), 2(b), and 2(c) illustrate states, respectively, before the start of formation of an object, during the forming process of the object, and a removing operation after the object formation;

FIG. 3 is a local sectional view of a pressure-sensitive adhesive sheet for build stage use according to another embodiment of the present invention.

### DESCRIPTION OF EMBODIMENTS

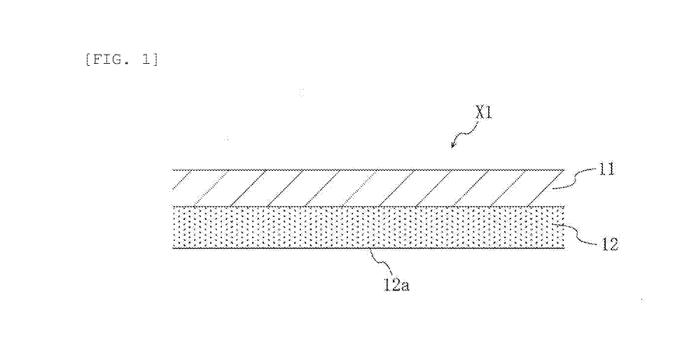

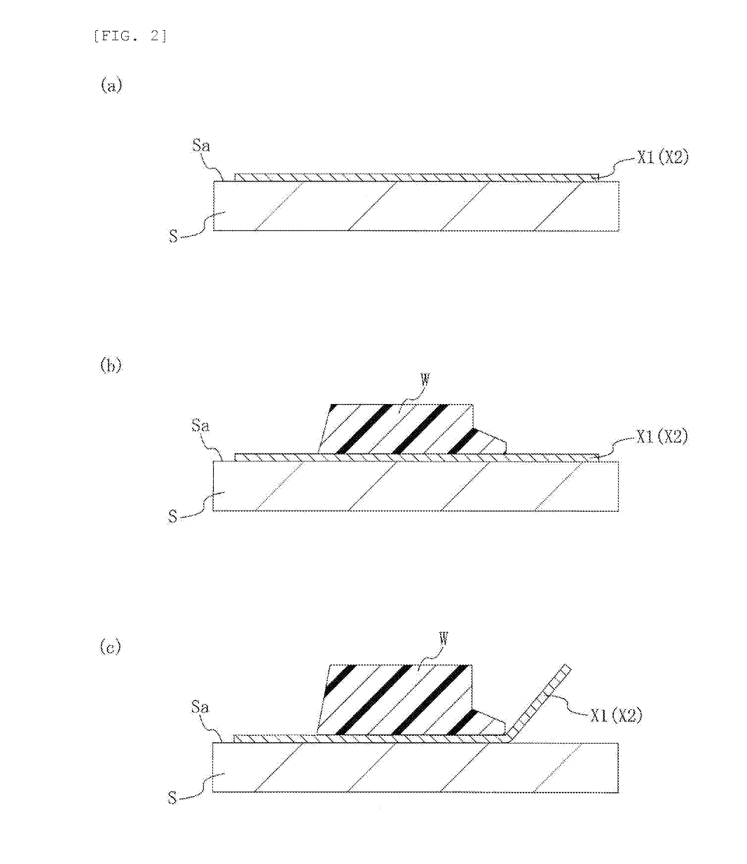

FIG. 1 is a local sectional view of a pressure-sensitive adhesive sheet X1, which is a pressure-sensitive adhesive sheet for build stage use according to one embodiment of the present invention. The pressure-sensitive adhesive sheet X1 is a single-sided pressure-sensitive adhesive sheet that has a multilayer structure including a substrate 11 and a pressure-sensitive adhesive layer 12. This pressure-sensitive adhesive sheet X1 is used for a build stage S of an additive manufacturing apparatus or another apparatus for the formation of an object, typically as illustrated in FIGS. 2(a), 2(b), and 2(c). Specifically, the pressure-sensitive adhesive sheet X1 is laminated onto an object-forming surface Sa of the build stage S before the start of the formation of an object, as illustrated in FIG. 2(a). In the lamination, the surface defined by the pressure-sensitive adhesive layer 12 of the pressure-sensitive adhesive sheet X1 is attached onto the object-forming surface Sa. In the object forming process during the operation of the apparatus, a target object W is gradually formed over the build stage S bearing the pressure-sensitive adhesive sheet X1 on its surface, as illustrated in FIG. 2(b), through a predetermined process according to an additive manufacturing technique employed in the additive manufacturing apparatus or another apparatus. Non-limiting examples of the additive manufacturing technique include fused deposition modeling, material jetting, stereolithography, and sheet lamination. In the object forming process as above, the pressure-sensitive adhesive sheet X1 adheres to the object-forming surface Sa of the build stage S, and the object W during its formation is attached to the pressure-sensitive adhesive sheet X1 on the build stage S. After the object formation, a removing operation or a detaching operation of the object W is performed, as illustrated in FIG. 2(c).

The substrate 11 of the pressure-sensitive adhesive sheet X1 is a unit that functions as a support (carrier) in the pressure-sensitive adhesive sheet X1 and constitutes or defines an object-attachment surface. Non-limiting examples of a material or materials to form the substrate 11 as above include paper materials, nonwoven fabrics, and plastic films. Namely, non-limiting examples of the substrate 11 include paper substrates, nonwoven fabric substrates, and plastic substrates.

Non-limiting examples of the paper materials to form the substrate 11 include Japanese paper, crepe paper, kraft paper, glassine paper, and synthetic paper. The category Japanese paper includes a mix paper containing beaten pulp such as wood pulp; and a mix paper further containing synthetic short fibers in addition to the pulp. Non-limiting examples of a material or materials to constitute the synthetic short fibers include rayon, polyamides, polyesters, polyethylenes, polypropylenes, polyurethanes, poly(vinyl alcohol)s, poly(vinyl chloride)s, poly(vinylidene chloride)s, and polyacrylonitriles.

Non-limiting examples of a material or materials to form the nonwoven fabrics to constitute the substrate 11 include pulp such as hemp pulp and wood pulp; rayon; acetate fibers; polyester fibers; polyamide fibers; polyolefin fibers; and poly(vinyl alcohol) fibers. Such nonwoven fabric fibers may be bonded with each other typically by impregnating the fibers with a binder resin.

Non-limiting examples of the plastic films to form the substrate 11 include polyolefin films, polyester films, polyimide resin films, polyamide resin films, vinyl chloride resin films, and vinyl acetate resin films. Non-limiting examples of the polyolefin films include polyethylene films, polypropylene films, and ethylene-propylene copolymer films. Non-limiting examples of the polyester films include poly(ethylene terephthalate) films.

The substrate 11 of the pressure-sensitive adhesive sheet X1 may include (be made from) each of different materials alone or in combination. The substrate 11 may be a laminate including two or more layers differing in component from each other. A surface of the substrate 11 facing the pressure-sensitive adhesive layer 12 may have undergone a surface treatment so as to have better adhesion with the pressure-sensitive adhesive layer 12. Non-limiting examples of the surface treatment include physical treatments such as corona treatment and plasma treatment; and chemical treatments such as primer coating. The substrate 11 as above has a thickness of typically 20 to 130 μm and a density of typically 0.1 to 0.8 g/cm³.

The pressure-sensitive adhesive layer 12 of the pressure-sensitive adhesive sheet X1 has an adhesive face 12a and is removably adherable to an object-forming surface of a build stage in an additive manufacturing apparatus. The pressure-sensitive adhesive layer 12 may be formed from a pressure-sensitive adhesive composition containing a pressure-sensitive adhesive as a principal component. As used herein, the term “principal component” refers to a component that occupies a largest mass proportion among all components. Non-limiting examples of the pressure-sensitive adhesive contained in the pressure-sensitive adhesive composition or in the pressure-sensitive adhesive layer 12 include acrylic polymers, which serve as acrylic pressure-sensitive adhesives; rubber pressure-sensitive adhesives; and silicone pressure-sensitive adhesives. The pressure-sensitive adhesive in the pressure-sensitive adhesive composition for pressure-sensitive adhesive layer 12 formation or in the pressure-sensitive adhesive layer 12 is present in a content of typically 50 to 100 mass percent.

Assume that an acrylic polymer is contained as the pressure-sensitive adhesive in the pressure-sensitive adhesive composition for pressure-sensitive adhesive layer 12 formation, accordingly, in the pressure-sensitive adhesive layer 12. In this case, the acrylic polymer may typically be a polymer including a monomer unit derived from an alkyl (meth)acrylate containing a linear or branched alkyl group, where the monomer unit is a principal monomer unit that is present in a largest mass proportion. As used herein, the term “(meta)acryl” refers to at least one of “acryl” and “methacryl”.

Non-limiting examples of the alkyl (meth)acrylate containing a linear or branched alkyl group, to form the monomer unit in the acrylic polymer, namely, non-limiting examples of the alkyl (meth)acrylate containing a linear or branched alkyl group, which is a monomer to form the acrylic polymer, include methyl (meth)acrylate, ethyl (meth)acrylate, propyl (meth)acrylate, isopropyl (meth)acrylate, n-butyl (meth)acrylate, s-butyl (meth)acrylate, isobutyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, isostearyl (meth)acrylate, nonadecyl (meth)acrylate, and eicosyl (meth)acrylate. The acrylic polymer to be contained in the pressure-sensitive adhesive composition for pressure-sensitive adhesive layer 12 formation, or in the pressure-sensitive adhesive layer 12, may be formed from each of different alkyl (meth)acrylates alone or in combination. In this embodiment, the alkyl (meth)acrylate to form the acrylic polymer is preferably at least one selected from the group consisting of n-butyl acrylate, 2-ethylhexyl acrylate, and methyl methacrylate. The monomer unit(s) derived from the alkyl (meth)acrylate(s) in the acrylic polymer is present in a content of typically 50 mass percent or more, preferably 60 mass percent or more, more preferably 70 mass percent or more, furthermore preferably 80 mass percent or more, and still more preferably 90 mass percent or more. The configurations relating to the alkyl (meth)acrylate content as above is advantageous for allowing the pressure-sensitive adhesive layer 12 to appropriately offer basic properties, such as tackiness, of the acrylic pressure-sensitive adhesive.

The acrylic polymer to be contained as a pressure-sensitive adhesive in the pressure-sensitive adhesive composition for pressure-sensitive adhesive layer 12 formation, or in the pressure-sensitive adhesive layer 12, may include a monomer unit derived from a (meth)acrylic ester having a cyclic structure (ring-containing (meth)acrylic ester). Non-limiting examples of the ring-containing (meth)acrylic ester to form the monomer unit in the acrylic polymer, namely, non-limiting examples of the ring-containing (meth)acrylic ester which is a copolymerizable monomer to form the acrylic polymer include cycloalkyl (meth)acrylates; (meth)acrylic esters containing a bicyclic hydrocarbon ring; (meth)acrylic esters containing a tricyclic or higher hydrocarbon ring; and (meth)acrylic esters containing an aromatic ring. Non-limiting examples of the cycloalkyl (meth)acrylates include cyclopentyl (meth)acrylate, cyclohexyl (meth)acrylate, cycloheptyl (meth)acrylate, and cyclooctyl (meth)acrylate. Non-limiting examples of the (meth)acrylic esters containing a bicyclic hydrocarbon ring include bornyl (meth)acrylate and isobornyl (meth)acrylate. Non-limiting examples of the (meth)acrylic esters containing a tricyclic or higher hydrocarbon ring include dicyclopentanyl (meth)acrylate, dicyclopentanyloxyethyl (meth)acrylate, tricyclopentanyl (meth)acrylate, 1-adamantyl (meth)acrylate, 2-methyl-2-adamantyl (meth)acrylate, and 2-ethyl-2-adamantyl (meth)acrylate. Non-limiting examples of the (meth)acrylic esters containing an aromatic ring include phenyl (meth)acrylate, phenoxyethyl (meth)acrylate, and benzyl (meth)acrylate. The acrylic polymer to be contained in the pressure-sensitive adhesive composition for pressure-sensitive adhesive layer 12 formation, or in the pressure-sensitive adhesive layer 12, may be formed from (derived from) monomers including each of different ring-containing (meth)acrylic esters alone or in combination. The monomer unit(s) derived from the ring-containing (meth)acrylic ester(s) is present in the acrylic polymer in a content of preferably 0.1 to 30 mass percent. This is preferred from the viewpoint of allowing the pressure-sensitive adhesive layer 12 to actually have appropriate flexibility.

The acrylic polymer to be contained as the pressure-sensitive adhesive in the pressure-sensitive adhesive composition for pressure-sensitive adhesive layer 12 formation, or in the pressure-sensitive adhesive layer 12, may include a monomer unit derived from a carboxy-containing monomer. The carboxy-containing monomer is a monomer that gives at least one carboxy group in the monomer unit. Such a carboxy group in the acrylic polymer can function typically as a crosslinking point that will react with an after-mentioned crosslinker. Non-limiting examples of the carboxy-containing monomer to constitute the monomer unit in the acrylic polymer, namely, non-limiting examples of the carboxy-containing monomer serving as a copolymerizable monomer to form the acrylic polymer include (meth)acrylic acid, itaconic acid, maleic acid, fumaric acid, crotonic acid, and isocrotonic acid. The acrylic polymer to be contained in the pressure-sensitive adhesive composition for pressure-sensitive adhesive layer 12 formation, or in the pressure-sensitive adhesive layer 12, may be formed from (derived from) monomers including each of different carboxy-containing monomers alone or in combination. In this embodiment, the carboxy-containing monomer for use for the formation of the acrylic polymer is preferably selected from the group consisting of acrylic acid and methacrylic acid. The monomer unit(s) derived from the carboxy-containing monomer(s) is present in the acrylic polymer in a content of preferably 0.1 to 20 mass percent. This is preferred for allowing the acrylic polymer as a pressure-sensitive adhesive to actually have a crosslinked structure appropriately.

The acrylic polymer to be contained as the pressure-sensitive adhesive in the pressure-sensitive adhesive composition for pressure-sensitive adhesive layer 12 formation, or in the pressure-sensitive adhesive layer 12, may include a monomer unit derived from a hydroxy-containing monomer. The hydroxy-containing monomer is a monomer that gives at least one hydroxy group in the monomer unit. Non-limiting examples of the hydroxy-containing monomer to form the monomer unit in the acrylic polymer, namely, non-limiting examples of the hydroxy-containing monomer serving as a copolymerizable monomer to form the acrylic polymer include hydroxy-containing (meth)acrylic esters, vinyl alcohol, and allyl alcohol. Non-limiting examples of the hydroxy-containing (meth)acrylic esters include 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, hydroxyoctyl (meth)acrylates, hydroxydecyl (meth)acrylates, hydroxylauryl (meth)acrylates, and 4-hydroxymethylcyclohexyl (meth)acrylate. The acrylic polymer to be contained in the pressure-sensitive adhesive composition for pressure-sensitive adhesive layer 12 formation, or in the pressure-sensitive adhesive layer 12, may be formed from (derived from) monomers containing each of different hydroxy-containing monomers alone or in combination. The monomer unit(s) derived from the hydroxy-containing monomer(s) is present in the acrylic polymer in a content of preferably 0.1 to 20 mass percent. This is preferred for allowing the pressure-sensitive adhesive layer 12 to actually have not only tackiness, but also appropriate cohesive force.

The acrylic polymer as above can be obtained by polymerizing a material monomer component or components. Non-limiting examples of the polymerization technique include solution polymerization, emulsion polymerization, and bulk polymerization. The solution polymerization, when to be performed, may employ a solvent or solvents such as aromatic hydrocarbons, aliphatic hydrocarbons, alicyclic hydrocarbons, esters, and ketones. The polymerization of the material monomer component(s) to form the acrylic polymer may employ a polymerization initiator. The polymerization initiator for use herein may be selected typically from photoinitiators and thermal initiators, according to the type of the polymerization reaction.

Assume that the pressure-sensitive adhesive composition for pressure-sensitive adhesive layer 12 formation, accordingly, the pressure-sensitive adhesive layer 12 contains a rubber pressure-sensitive adhesive as the pressure-sensitive adhesive. In this case, non-limiting examples of the rubber pressure-sensitive adhesive include synthetic rubbers such as diene synthetic rubbers and non-diene synthetic rubbers; and natural rubbers. Non-limiting examples of the diene synthetic rubbers include isoprene rubber, butadiene rubber, styrene-butadiene rubber, and chloroprene rubber. Non-limiting examples of the non-diene rubbers include isobutylene-isoprene rubber, ethylene-propylene rubber, urethane rubber, and silicone rubber.

The pressure-sensitive adhesive composition for pressure-sensitive adhesive layer 12 formation and, accordingly, the pressure-sensitive adhesive layer 12 may contain a crosslinker to crosslink molecules of the polymer with each other. The crosslinking reaction between molecules of the polymer by the crosslinker, when used, enables the control of the gel fraction of the pressure-sensitive adhesive layer 12. Non-limiting examples of the crosslinker as above include oxazoline crosslinkers, epoxy crosslinkers, and isocyanate crosslinkers.

The oxazoline crosslinkers are compounds containing an oxazoline ring in the molecule. Examples of such oxazoline crosslinkers include monomers containing an oxazoline ring; and polymers including a monomer unit derived from an oxazoline-ring-containing monomer. Non-limiting examples of the oxazoline crosslinkers as above include commercial products such as EPOCROS K-2010E, EPOCROS K-2020E, EPOCROS K-2030E, EPOCROS WS-300, EPOCROS WS-500, and EPOCROS WS-700 (each supplied by Nippon Shokubai Co., Ltd.).

Non-limiting examples of the epoxy crosslinkers include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl tris(2-hydroxyethyl)isocyanurate, resorcinol diglycidyl ether, and bisphenol-S diglycidyl ether. Non-limiting examples of the epoxy crosslinkers also include epoxy resins containing two or more epoxy groups in the molecule. In addition, non-limiting examples of the epoxy crosslinkers further include commercial products available typically under trade name TETRAD C (from MITSUBISHI GAS CHEMICAL COMPANY, INC.).

Non-limiting examples of the isocyanate crosslinkers include lower aliphatic polyisocyanates, alicyclic polyisocyanates, and aromatic polyisocyanates. Non-limiting examples of the lower aliphatic polyisocyanates include 1,2-ethylene diisocyanate, 1,4-butylene diisocyanate, and 1,6-hexamethylene diisocyanate. Non-limiting examples of the alicyclic polyisocyanates include cyclopentylene diisocyanate, cyclohexylene diisocyanate, isophorone diisocyanate, hydrogenated tolylene diisocyanates, and hydrogenated xylene diisocyanates. Non-limiting examples of the aromatic polyisocyanates include 2,4-tolylene diisocyanate, 2,6-tolylene diisocyanate, 4,4′-diphenylmethane diisocyanate, and xylylene diisocyanates. Non-limiting examples of the isocyanate crosslinkers also include commercial products such as a trimethylolpropane/tolylene diisocyanate adduct CORONATE L (trade name, supplied by Nippon Polyurethane Industry Co., Ltd.), a trimethylolpropane/hexamethylene diisocyanate adduct CORONATE HL (trade name, supplied by Nippon Polyurethane Industry Co., Ltd.), and a trimethylolpropane/xylylene diisocyanate adduct TAKENATE D-110N (trade name, supplied by Mitsui Chemicals Inc.).

The pressure-sensitive adhesive composition for pressure-sensitive adhesive layer 12 formation, or the pressure-sensitive adhesive layer 12, may contain each of different crosslinkers alone or in combination. Assume that the pressure-sensitive adhesive composition for pressure-sensitive adhesive layer 12 formation or the pressure-sensitive adhesive layer 12 contains a crosslinker or crosslinkers. In this case, the pressure-sensitive adhesive composition or the pressure-sensitive adhesive layer 12 contains the crosslinker(s) in a content of preferably 0.1 to 15 mass percent. This is preferred from the viewpoint of allowing the pressure-sensitive adhesive layer 12 to actually have sufficient reliability in bonding to an adherend.

The pressure-sensitive adhesive composition for pressure-sensitive adhesive layer 12 formation or the pressure-sensitive adhesive layer 12 may further contain one or more other components within ranges not adversely affecting advantageous effects of the present invention, in addition to the above-mentioned components. Non-limiting examples of such other components include cross-linking promoters, tackifiers, softeners, fillers, age inhibitors (antioxidants), silane coupling agents, surfactants, and colorants such as pigments and dyes.

The pressure-sensitive adhesive layer 12 has a thickness of typically 3 to 200 μm, and preferably 5 to 100 μm.

The pressure-sensitive adhesive sheet X1, which has the multilayer structure as above, has a puncture strength of 3.3 to 12 N, preferably 4 to 6.5 N, and more preferably 4.3 to 6.5 N, where the puncture strength is determined as a maximum load during a process in which a probe having a hemispherical head with the radius of curvature of 0.5 mm pierces the pressure-sensitive adhesive sheet at a travel speed of 0.2 mm/s. The puncture strength as above can be measured typically using a puncture strength tester (needle piercing strength tester) KES-G5 (trade name, supplied by KATO TECH CO., LTD.). The measurement is performed at a temperature of typically 23° C. The measurement may be performed typically by a procedure as follows. A jig used herein is one that holds the measuring target while leaving a round aperture (having a diameter of typically 11 mm) exposed at both sides of the target. While the measuring target is held by the jig, a probe is allowed to pierce the central portion of the round aperture under the above-mentioned conditions. Non-limiting examples of a technique or techniques to control the puncture strength of the pressure-sensitive adhesive sheet X1 within the range include components selection, density adjustment, and thickness adjustment, for the substrate 11; and thickness adjustment, composition and content adjustment of the pressure-sensitive adhesive, crosslinker selection, crosslinker content adjustment, other additives selection, and additives content adjustment, for the pressure-sensitive adhesive layer(s) (the pressure-sensitive adhesive layer 12 in the embodiment).

The configuration, where the pressure-sensitive adhesive sheet X1 has a puncture strength of 3.3 N or more as determined by the procedure, is suitable for allowing the pressure-sensitive adhesive sheet X1 to avoid rupturing typically in the removing operation described above with reference to FIG. 2(c). In some designs, the object W to be formed over the build stage S has a sharp portion and/or a protruded portion at an end facing the build stage; and, in the removing operation, the sharp portion and/or the protruded portion of the object may bump against the pressure-sensitive adhesive sheet X1 during pulling away and removing of the pressure-sensitive adhesive sheet X1 from the build stage S. For example in such a case, the configuration, where the pressure-sensitive adhesive sheet X1 has a puncture strength of 3.3 N or more as determined by the procedure, is suitable for allowing the pressure-sensitive adhesive sheet X1 to keep from or resist rupturing. The configuration, where the pressure-sensitive adhesive sheet X1 has a puncture strength of 12 N or less as determined by the procedure, is suitable for allowing the pressure-sensitive adhesive sheet X1 to keep from having excessive stiffness and to surely offer good deformability required in the removing operation as above. As described above, the pressure-sensitive adhesive sheet X1, which has the configurations relating to the puncture strength, is suitable for surely offering good deformability required in the removing operation from the build stage S, while keeping from or resisting rupturing in the removing operation. The pressure-sensitive adhesive sheet X1 as above, when used in the above manner for the formation of the object W typically by an additive manufacturing apparatus, can dispense with or minimize the use of a scraper or another tool having a sharp edge to detach the object W from the build stage S. Accordingly, the pressure-sensitive adhesive sheet X1 is suitable for detaching the object W, which is formed over the build stage S of an additive manufacturing apparatus or another apparatus, from the build stage S, while less causing significant damage to the object W. The pressure-sensitive adhesive sheet X1, which can dispense with or minimize the use of a tool having a sharp edge to detach the object W from the build stage S, is also advantageous for less causing damage to the build stage S upon detachment of the object.

The pressure-sensitive adhesive sheet X1 has a fracture energy of preferably 0.24 to 4 N·m, and more preferably 0.28 to 2.5 N·m, where the fracture energy is energy necessary to cause rupture of the pressure-sensitive adhesive sheet in a tensile break test performed at a sample width of 18 mm, a gripping distance of 125 mm, and a tensile speed of 300 mm/min. The fracture energy (E) can be determined according to following Expression (1), in which integration is performed in the range from the deformation amount of the measuring target or sample piece at the start of the measurement (x=0) to the deformation amount of the sample piece at break (at rupture), where the deformation amounts are determined in the tensile direction. In Expression (1), F(x) represents the tensile force that acts upon the measuring target or sample piece in the tensile break test.

[Math. 1]

E=∫F(x)·dx (1)

The fracture energy as above can be measured typically using a tensile break tester (universal tensile tester) Autograph AG-20 kNG (trade name, supplied by Shimadzu Corporation). The measurement may be performed at a temperature of typically 23° C. In the measurement, the measuring target is secured to a pair of chucks (disposed at a distance in the tensile direction) of the tester, and the gripping distance (chuck-to-chuck distance) at the start of the measurement (x=0) is set at 125 mm as described above. Non-limiting examples of a technique or techniques to control the fracture energy of the pressure-sensitive adhesive sheet X1 within the range include components selection, density adjustment, and thickness adjustment, for the substrate 11; and thickness adjustment, composition and content adjustment of the pressure-sensitive adhesive, crosslinker selection, crosslinker content adjustment, other additives selection, and additives contents adjustment, for the pressure-sensitive adhesive layer(s) (the pressure-sensitive adhesive layer 12 in the embodiment).

The fracture energy of the pressure-sensitive adhesive sheet X1 may serve as an index for the toughness of the pressure-sensitive adhesive sheet X1. The configuration, where the pressure-sensitive adhesive sheet X1 has a fracture energy of 0.24 N·m or more as determined by the procedure, is advantageous for allowing the pressure-sensitive adhesive sheet X1 to actually have sufficient toughness or strength as to resist rupturing. The configuration, where the pressure-sensitive adhesive sheet X1 has a fracture energy of 4 N·m or less as determined by the procedure, is advantageous for allowing the pressure-sensitive adhesive sheet X1 to surely offer good deformability during the removing operation, while surely having such toughness or strength as above.

In addition, the pressure-sensitive adhesive sheet X1 has a tensile strain at break of preferably 4% to 50%, more preferably 4% to 45%, and furthermore preferably 5% to 31%. The tensile strain at break, namely, breaking elongation, is the ratio (percentage) of the deformation amount or elongated length of the measuring target or sample piece at break (rupture) to the initial length of the sample piece at the start of the measurement, where the lengths are determined in the tensile direction. The tensile strain at break as above can be measured typically using a tensile break tester (universal tensile tester) Autograph AG-20 kNG (trade name, supplied by Shimadzu Corporation). The measurement may be performed at a temperature of typically 23° C. Non-limiting examples of a technique or techniques to control the tensile strain at break of the pressure-sensitive adhesive sheet X1 within the range include components selection, density adjustment, and thickness adjustment, for the substrate 11; and thickness adjustment, composition and content adjustment of the pressure-sensitive adhesive, crosslinker selection, crosslinker content adjustment, other additives selection, and additives contents adjustment, for the pressure-sensitive adhesive layer(s) (the pressure-sensitive adhesive layer 12 in the embodiment).

The configuration, where the pressure-sensitive adhesive sheet X1 has a tensile strain at break, namely, a breaking elongation of 4% or more, is advantageous for dispersing stress at a site where the object W or a portion, such as a sharp portion and/or a protruded portion, of the object bumps against the pressure-sensitive adhesive sheet X1 during pulling away and removing of the pressure-sensitive adhesive sheet X1 from the build stage S typically in the removing operation described above with reference to FIG. 2(c). The stress dispersion as above contributes to allowing the pressure-sensitive adhesive sheet X1 to resist rupturing during the removing operation. The stress dispersion also contributes to less causing significant damage to the object W during the removing operation. In contrast, the configuration, where the pressure-sensitive adhesive sheet X1 has a tensile strain at break, namely, a breaking elongation of 50% or less, is advantageous for allowing the pressure-sensitive adhesive sheet X1 to surely have sufficient strength to resist rupturing.

In addition, the pressure-sensitive adhesive sheet X1 or the pressure-sensitive adhesive layer 12 thereof has a first 90-degree peel strength from at least one selected from the group consisting of an acrylic plane, an aluminum plane, and a polyimide plane of 0.5 to 15 N/18 mm, where the first 90-degree peel strength is measured at a peel temperature of 23° C. and a tensile speed of 300 mm/min. The first 90-degree peel strength as above can be measured typically using a TENSILON Type Peel Tester TMC-1 kNB (trade name, supplied by TAMSUI CORPORATION). The measurement may be performed on a test target or test specimen having a width of 18 mm at a measurement temperature or peel temperature of 23° C. as described above, a peel angle of 90 degrees, and a tensile speed of 300 mm/min as described above. As used herein, the term “acrylic plane” refers to a plane of an acrylic resin member, such as an acrylic resin plate, containing an acrylic resin in a content of 95 mass percent or more. Also as used herein, the term “polyimide plane” refers to a plane of a polyimide resin member, such as a polyimide resin sheet or a polyimide substrate for pressure-sensitive adhesive tapes, containing a polyimide resin in a content of 95 mass percent or more. Non-limiting examples of a technique or techniques to control the adhesive strength (peel strength) of the pressure-sensitive adhesive layer 12 within the range include composition and content adjustment of the pressure-sensitive adhesive, crosslinker selection, crosslinker content adjustment, and thickness adjustment, for the pressure-sensitive adhesive layer(s) (the pressure-sensitive adhesive layer 12 in the embodiment).

Some additive manufacturing apparatuses include a build stage S that is made from an acrylic resin in at least the object-forming surface Sa; or include a build stage S that is made of aluminum in at least the object-forming surface Sa; or bear a polyimide sheet laminated on the object-forming surface Sa of the build stage S before use. The configuration, where the pressure-sensitive adhesive sheet X1 has a first 90-degree peel strength of 0.5 N/18 mm or more as determined under the above-described conditions, is advantageous for allowing the pressure-sensitive adhesive sheet X1 to resist separation and gap from the surface of the build stage S and, consequently, is advantageous for allowing the object W during its formation to resist displacement on the pressure-sensitive adhesive sheet X1, typically during the object forming process described above with reference to FIG. 2(b). The configuration, where the pressure-sensitive adhesive sheet X1 has a first 90-degree peel strength of 15 N/18 mm or less as determined under the conditions, is advantageous for allowing the pressure-sensitive adhesive sheet X1 to surely have good removability from the build stage S. In addition, the configuration, where the pressure-sensitive adhesive sheet X1 has a first 90-degree peel strength of 15 N/18 mm or less as determined under the conditions, is also advantageous for allowing the pressure-sensitive adhesive sheet X1 to less leave adhesive residue on the build stage S upon removal of the pressure-sensitive adhesive sheet X1 from the build stage S.

In addition, the pressure-sensitive adhesive sheet X1 or the pressure-sensitive adhesive layer 12 thereof preferably has a second 90-degree peel strength from an aluminum plane or a polyimide plane of 0.5 to 15 N/18 mm, where the second 90-degree peel strength is measured at a peel temperature of 23° C. and a tensile speed of 300 mm/min after the pressure-sensitive adhesive sheet undergoes lamination onto the plane, subsequent heat treatment at 100° C. for 24 hours, and subsequent cooling down. The second 90-degree peel strength as above can be measured typically using a TENSILON Type Peel Tester TMC-1 kNB (trade name, supplied by TAMSUI CORPORATION). The measurement may be performed on a test target or test specimen having a width of 18 mm at a measurement temperature or peel temperature of 23° C. as described above, a peel angle of 90 degrees, and a tensile speed of 300 mm/min as described above. Non-limiting examples of a technique or techniques to control the adhesive strength (peel strength) of the pressure-sensitive adhesive layer 12 within the range include composition and content adjustments of the pressure-sensitive adhesive, crosslinker selection, crosslinker content adjustment, and thickness adjustment, for the pressure-sensitive adhesive layer(s) (the pressure-sensitive adhesive layer 12 in the embodiment), as described above.

Some additive manufacturing apparatuses include a build stage S that is made of aluminum in at least the object-forming surface Sa and has a heating function; and/or bear a polyimide sheet laminated, before use, onto the object-forming surface Sa of a build stage S having a heating function. The configuration, where the pressure-sensitive adhesive sheet X1 has a second 90-degree peel strength of 0.5 N/18 mm or more as determined under the above-described conditions after the heating process, is advantageous for allowing the pressure-sensitive adhesive sheet X1 to resist separation and gap from the surface of the build stage S with heating function and, consequently, is advantageous for allowing the object W during its formation to resist displacement on the pressure-sensitive adhesive sheet X1, typically in the object forming process described above with reference to FIG. 2(b). The configuration, where the pressure-sensitive adhesive sheet X1 has a second 90-degree peel strength of 15 N/18 mm or less as determined under the conditions after the heating process, is advantageous for allowing the pressure-sensitive adhesive sheet X1 to surely have good removability from a build stage S having a heating function. In addition, the configuration, where the pressure-sensitive adhesive sheet X1s has a second 90-degree peel strength of 15 N/18 mm or less as determined under the conditions after the heating process, is also advantageous for allowing the pressure-sensitive adhesive sheet X1 to less leave adhesive residue on a build stage S having a heating function, upon removal of the pressure-sensitive adhesive sheet X1 from the build stage S.

The pressure-sensitive adhesive sheet X1 as above may be produced typically by applying the pressure-sensitive adhesive composition for pressure-sensitive adhesive layer 12 formation onto a substrate 11 to form a pressure-sensitive adhesive composition layer, drying the applied composition, and, as needed, allowing a crosslinking reaction to proceed on the pressure-sensitive adhesive composition layer. The pressure-sensitive adhesive sheet X1, which is produced typically by a procedure as above, may be in the form of a roll as being coated typically with a release agent on an opposite side of the substrate 11 to the pressure-sensitive adhesive layer 12 and then being wound into the roll. The pressure-sensitive adhesive sheet X1 may bear a separator (release liner) so as to cover the adhesive face 12a of the pressure-sensitive adhesive layer 12. The separator is a part that protects the pressure-sensitive adhesive layer 12 of the pressure-sensitive adhesive sheet X1 from being exposed and is released or removed from the pressure-sensitive adhesive sheet X1 upon lamination of the pressure-sensitive adhesive sheet X1 onto an adherend. Non-limiting examples of the separator include bases having a release coat layer; low-adhesive bases made from fluorocarbon polymers; and low-adhesive bases made from nonpolar polymers. The separator has a thickness of typically 5 to 200 μm.

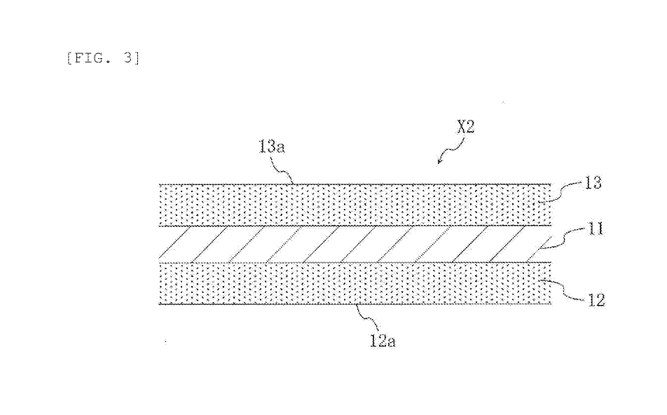

FIG. 3 is a local sectional view of a pressure-sensitive adhesive sheet X2, which is a pressure-sensitive adhesive sheet for build stage use according to another embodiment of the present invention. The pressure-sensitive adhesive sheet X2 is a double-sided pressure-sensitive adhesive sheet that has a multilayer structure including a substrate 11, a pressure-sensitive adhesive layer 12 (first pressure-sensitive adhesive layer), and a pressure-sensitive adhesive layer 13 (second pressure-sensitive adhesive layer), where the substrate 11 is disposed between the pressure-sensitive adhesive layers 12 and 13. The pressure-sensitive adhesive sheet X2 differs from the pressure-sensitive adhesive sheet X1 in further including the pressure-sensitive adhesive layer 13. The pressure-sensitive adhesive sheet X2 as above may be used typically on or for a build stage S of an additive manufacturing apparatus or another apparatus to form an object, typically as illustrated in FIGS. 2(a), 2(b), and 2(c), as with the pressure-sensitive adhesive sheet X1.

The substrate 11 of the pressure-sensitive adhesive sheet X2 is a unit that functions as a support (carrier) in the pressure-sensitive adhesive sheet X2. The components and thickness of substrate 11 of the pressure-sensitive adhesive sheet X2 are as with the components and thickness of the substrate 11 of the pressure-sensitive adhesive sheet X1, as described above.

The pressure-sensitive adhesive layer 12 of the pressure-sensitive adhesive sheet X2 has an adhesive face 12a. The adhesive face 12a serves typically as a face that is removably adherable to an object-forming surface Sa of a build stage S in an additive manufacturing apparatus. The configurations of the pressure-sensitive adhesive layer 12 of the pressure-sensitive adhesive sheet X2 are as with the configurations of the pressure-sensitive adhesive layer 12 of the pressure-sensitive adhesive sheet X1, as described above.

The pressure-sensitive adhesive layer 13 of the pressure-sensitive adhesive sheet X2 has an adhesive face 13a. The adhesive face 13a serves typically as a face to which an object W is attached in an object forming process by the additive manufacturing apparatus. The pressure-sensitive adhesive layer 13 is typically a layer formed from a pressure-sensitive adhesive composition containing, as a principal component, a pressure-sensitive adhesive selected from an acrylic polymer serving as an acrylic pressure-sensitive adhesive, a rubber pressure-sensitive adhesive, and a silicone pressure-sensitive adhesive. Specifically, the components of the pressure-sensitive adhesive layer 13 are as with the components of the pressure-sensitive adhesive layer 12 of the pressure-sensitive adhesive sheet X1, as described above. The pressure-sensitive adhesive layer 13 may have a component composition (formulation) identical to or different from the component composition of the pressure-sensitive adhesive layer 12 in the pressure-sensitive adhesive sheet X2. The pressure-sensitive adhesive layer 13 as above has a thickness of typically 3 to 200 μm, and preferably 5 to 100 μm.

In the pressure-sensitive adhesive sheet X2, it is also acceptable that the adhesive face 13a of the pressure-sensitive adhesive layer 13 serves as a face that is removably adherable to the object-forming surface Sa of the build stage S, and the adhesive face 12a of the pressure-sensitive adhesive layer 12 serves as a face to which the object W is attached in the object forming process.

The pressure-sensitive adhesive sheet X2 having the multilayer structure as above has a puncture strength of 3.3 to 12 N, preferably 4 to 6.5 N, and more preferably 4.3 to 6.5 N, where the puncture strength is determined as a maximum load during a process in which a probe having a hemispherical head with the radius of curvature of 0.5 mm pierces the pressure-sensitive adhesive sheet at a travel speed of 0.2 mm/s. The puncture strength as above can be measured typically using a puncture strength tester (needle piercing strength tester) KES-G5 (trade name, supplied by KATO TECH CO., LTD.). The measurement technique and control technique for the puncture strength of the pressure-sensitive adhesive sheet X2 are as with the measurement technique and control technique as described above for the puncture strength of the pressure-sensitive adhesive sheet X1.

The configuration, where the pressure-sensitive adhesive sheet X2 has a puncture strength of 3.3 N or more as determined by the procedure, is suitable for allowing the pressure-sensitive adhesive sheet X2 to keep from rupturing typically in a removing operation as illustrated in FIG. 2(c). In some designs, the object W to be formed over the build stage S has a sharp portion and/or a protruded portion at an end facing the build stage; and, in the removing operation, the sharp portion and/or the protruded portion of the object may bump against the pressure-sensitive adhesive sheet X2 during pulling away and removing of the pressure-sensitive adhesive sheet X2 from the build stage S. For example in such a case, the configuration, where the pressure-sensitive adhesive sheet X2 has a puncture strength of 3.3 N or more as determined by the procedure, is suitable for avoiding or minimizing the rupture of the pressure-sensitive adhesive sheet X2. The pressure-sensitive adhesive sheet X2 has a puncture strength of 12 N or less as determined by the procedure. This configuration is suitable for allowing the pressure-sensitive adhesive sheet X2 to keep from having excessive stiffness and to surely offer good deformability required in the removing operation as described above. As described above, the pressure-sensitive adhesive sheet X2, which has the configurations relating to the puncture strength, is suitable for surely offering good deformability required in a removing operation from the build stage S, while keeping from or resisting rupturing during the removing operation. The pressure-sensitive adhesive sheet X2 as above, when used for the formation of an object W typically by an additive manufacturing apparatus, can dispense with or minimize the use of a scraper or another tool having a sharp edge to detach the object W from the build stage S. Accordingly, the pressure-sensitive adhesive sheet X2 is suitable for detaching the object W, which is formed over a build stage S of an additive manufacturing apparatus or another apparatus, from the build stage S, while less causing significant damage to the object W. The pressure-sensitive adhesive sheet X2, which can dispense with or minimize the use of a tool having a sharp edge to detach the object W from the build stage S, is also advantageous for minimizing damage to the build stage S upon detachment of the object.

The pressure-sensitive adhesive sheet X2 has a fracture energy of preferably 0.24 to 4 N·m, and more preferably 0.28 to 2.5 N·m, where the fracture energy is energy necessary to cause rupture of the pressure-sensitive adhesive sheet in a tensile break test performed at a sample width of 18 mm, a gripping distance of 125 mm, and a tensile speed of 300 mm/min. The fracture energy as above can be measured typically using a tensile break tester (universal tensile tester) Autograph AG-20 kNG (trade name, supplied by Shimadzu Corporation). The measurement technique, derivation technique, and control technique for the fracture energy of the pressure-sensitive adhesive sheet X2 are as with the measurement technique, derivation technique, and control technique as described above for the fracture energy of the pressure-sensitive adhesive sheet X1.

The fracture energy of the pressure-sensitive adhesive sheet X2 may serve as an index for toughness of the pressure-sensitive adhesive sheet X2. The configuration, where the pressure-sensitive adhesive sheet X2 has a fracture energy of 0.24 N·m or more as determined by the procedure, is advantageous for allowing the pressure-sensitive adhesive sheet X2 to actually have sufficient toughness or strength to resist rupturing. The configuration, where the pressure-sensitive adhesive sheet X2 has a fracture energy of 4 N·m or less as determined by the procedure, is advantageous for allowing the pressure-sensitive adhesive sheet X2 to have good deformability upon the removing operation while surely having such toughness or strength.

In addition, the pressure-sensitive adhesive sheet X2 has a tensile strain at break of preferably 4% to 50%, more preferably 4% to 45%, and furthermore preferably 5% to 31%. The tensile strain at break as above can be measured typically using a tensile break tester (universal tensile tester) Autograph AG-20 kNG (trade name, supplied by Shimadzu Corporation). The measurement technique and control technique for the tensile strain at break of the pressure-sensitive adhesive sheet X2 are as with the measurement technique and control technique as described above for the tensile strain at break of the pressure-sensitive adhesive sheet X1.

The configuration, where the pressure-sensitive adhesive sheet X2 has a tensile strain at break, namely, a breaking elongation of 4% or more, is advantageous for dispersing stress at a site where the object W, or a portion, such as a sharp portion and/or a protruded portion, of the object bumps against the pressure-sensitive adhesive sheet X2 during pulling away and removing of the pressure-sensitive adhesive sheet X2 from the build stage typically in the removing operation as illustrated in FIG. 2(c). The stress dispersion as above contributes to allowing the pressure-sensitive adhesive sheet X2 to resist rupturing during the removing operation. The stress dispersion also contributes to less causing significant damage to the object W during the removing operation. In contrast, the configuration, where the pressure-sensitive adhesive sheet X2 has a tensile strain at break, namely, a breaking elongation of 50% or less, is advantageous for allowing the pressure-sensitive adhesive sheet X2 to surely have sufficient strength to resist rupturing.

In addition, the pressure-sensitive adhesive sheet X2, or at least one of the pressure-sensitive adhesive layer 12 and the pressure-sensitive adhesive layer 13 thereof, preferably has a first 90-degree peel strength from at least one selected from the group consisting of an acrylic plane, an aluminum plane, and a polyimide plane of 0.5 to 15 N/18 mm, where the first 90-degree peel strength is measured at a peel temperature of 23° C. and a tensile speed of 300 mm/min. The first 90-degree peel strength as above can be measured typically using a TENSILON Type Peel Tester TMC-1 kNB (trade name, supplied by TAMSUI CORPORATION). The measurement technique and control technique for the first 90-degree peel strength of the pressure-sensitive adhesive sheet X2 are as with the measurement technique and control technique as described above for the first 90-degree peel strength of the pressure-sensitive adhesive sheet X1.

Some additive manufacturing apparatuses include a build stage S that is made from an acrylic resin in at least the object-forming surface Sa; or include a build stage S that is made of aluminum in at least the object-forming surface Sa; or bear a polyimide sheet laminated on the object-forming surface Sa of the build stage S before use. The configuration, where the pressure-sensitive adhesive sheet X2 has a first 90-degree peel strength of 0.5 N/18 mm or more as determined under the above-described conditions, is advantageous for allowing the pressure-sensitive adhesive sheet X2 to resist separation and gap from the surface of the build stage S and, consequently, is advantageous for allowing the object W during its formation to resist displacement on the pressure-sensitive adhesive sheet X2, typically during the object forming process described above with reference to FIG. 2(b). The configuration, where the pressure-sensitive adhesive sheet X2 has a first 90-degree peel strength of 15 N/18 mm or less as determined under the conditions, is advantageous for allowing the pressure-sensitive adhesive sheet X2 to surely have good removability from the build stage S. In addition, the configuration, where the pressure-sensitive adhesive sheet X2 has a first 90-degree peel strength of 15 N/18 mm or less as determined under the conditions, is also advantageous for allowing the pressure-sensitive adhesive sheet X2 to less leave adhesive residue on the build stage S upon removal of the pressure-sensitive adhesive sheet X2 from the build stage S.

In addition, the pressure-sensitive adhesive sheet X2, or at least one of the pressure-sensitive adhesive layer 12 and the pressure-sensitive adhesive layer 13 thereof, preferably has a second 90-degree peel strength from an aluminum plane or a polyimide plane of 0.5 to 15 N/18 mm, where the second 90-degree peel strength is measured at a peel temperature of 23° C. and a tensile speed of 300 mm/min after the pressure-sensitive adhesive sheet undergoes lamination onto the aluminum plane or the polyimide plane, subsequent heat treatment at 100° C. for 24 hours, and subsequent cooling down. The 90-degree peel strength as above can be measured typically using a TENSILON Type Peel Tester TMC-1 kNB (trade name, supplied by TAMSUI CORPORATION). The measurement technique and control technique for the second 90-degree peel strength of the pressure-sensitive adhesive sheet X2 are as with the measurement technique and control technique as described above for the second 90-degree peel strength of the pressure-sensitive adhesive sheet X1.

Some additive manufacturing apparatuses include a build stage S that is made of aluminum in at least the object-forming surface Sa and has a heating function; and/or bear a polyimide sheet laminated, before use, onto the object-forming surface Sa of a build stage S having a heating function. The configuration, where the pressure-sensitive adhesive sheet X2 has a second 90-degree peel strength of 0.5 N/18 mm or more as determined under the above-described conditions after the heating process, is advantageous for allowing the pressure-sensitive adhesive sheet X2 to resist separation and gap from the surface of the build stage S having a heating function and, consequently, is advantageous for allowing the object W during its formation to resist displacement on the pressure-sensitive adhesive sheet X2, typically during the object forming process described above with reference to FIG. 2(b). The configuration, where the pressure-sensitive adhesive sheet X2 has a second 90-degree peel strength of 15 N/18 mm or less as determined under the conditions after the heating process, is advantageous for allowing the pressure-sensitive adhesive sheet X2 to surely have good removability from the build stage S having a heating function. In addition, the configuration, where the pressure-sensitive adhesive sheet X2 has a second 90-degree peel strength of 15 N/18 mm or less as determined under the conditions after the heating process, is also advantageous for allowing the pressure-sensitive adhesive sheet X2 to less leave adhesive residue on a build stage S having a heating function, upon removal of the pressure-sensitive adhesive sheet X2 from the build stage S.

In the pressure-sensitive adhesive sheet X2, the surface to which the object W is attached in the object forming process by the additive manufacturing apparatus is an adhesive face. This configuration is advantageous for the object W during its formation to resist displacement over the build stage S.

The pressure-sensitive adhesive sheet X2 as above may be produced typically by a procedure as follows. Initially, a pressure-sensitive adhesive composition for pressure-sensitive adhesive layer 12 formation, and a pressure-sensitive adhesive composition for pressure-sensitive adhesive layer 13 formation are prepared independently. Next, the pressure-sensitive adhesive composition for pressure-sensitive adhesive layer 12 formation is applied onto a first release liner with release-treated surface to form a pressure-sensitive adhesive composition layer, and the pressure-sensitive adhesive composition layer is dried. This gives a pressure-sensitive adhesive layer 12 on the first release liner. On the other hand, the pressure-sensitive adhesive composition for pressure-sensitive adhesive layer 13 formation is applied onto a second release liner with release-treated surface to form a pressure-sensitive adhesive composition layer, and the pressure-sensitive adhesive composition layer is dried. This gives a pressure-sensitive adhesive layer 13 on the second release liner. The pressure-sensitive adhesive layer 12 is then laminated on one side of a substrate 11, and the pressure-sensitive adhesive layer 13 is laminated on the other side of the substrate 11. Thereafter, the pressure-sensitive adhesive layers 12 and 13 are, as needed, further subjected to drying or to a crosslinking reaction as proceeding.

The pressure-sensitive adhesive sheet X2 produced typically by a procedure as above may be in the form of a roll, formed by winding the pressure-sensitive adhesive sheet X2 with a separator (release liner) disposed so as to cover the surface (adhesive face 12a) of the pressure-sensitive adhesive layer 12, or with a separator (release liner) disposed so as to cover the surface (adhesive face 13a) of the pressure-sensitive adhesive layer 13. The pressure-sensitive adhesive sheet X2 may bear a pair of separators (release liners) so as to cover the adhesive faces 12a and 13a. The separator(s) is removed from the pressure-sensitive adhesive sheet X2 upon lamination of the pressure-sensitive adhesive sheet X2 onto an adherend. Non-limiting examples of the separator(s) include bases having a release coat layer; low-adhesive bases made from fluorocarbon polymers; and low-adhesive bases made from nonpolar polymers. The separator(s) has a thickness of typically 5 to 200 μm.

### EXAMPLES

### Example 1

A pressure-sensitive adhesive sheet for build stage use according to Example 1 was prepared by a procedure as follows. Specifically, initially, a mixture containing 50 parts by mass of water and 0.2 part by mass of potassium persulfate was stirred for one hour in a reactor equipped with a reflux condenser, a nitrogen gas inlet tube, a stirrer, and a thermometer, while introducing nitrogen gas into the reactor. On the other hand, an emulsified solution was prepared through emulsification, where the emulsified solution contained 93 parts by mass of 2-ethylhexyl acrylate (2EHA), 5 parts by mass of methyl methacrylate (MMA), 2 parts by mass of acrylic acid (AA), 2 parts by mass of sodium lauryl sulfate, 1 part by mass of a polyoxyethylene lauryl ether, and 50 parts by mass of water. The emulsified solution was added dropwise to the mixture, after nitrogen purge, at 70° C. over 3 hours. The reaction solution after the dropwise addition was aged at 70° C. for 2 hours. The reaction solution was then cooled down to room temperature and neutralized with a 10 mass percent ammonia water. This gave a solution (acrylic polymer solution P1) containing an acrylic polymer, which is a copolymer of 2EHA, MMA, and AA. The acrylic polymer solution P1 had a solids concentration of 46.5 mass percent.

Next, 100 parts by mass of the acrylic polymer solution P1 were combined with 1 part by mass of a water-soluble oxazoline crosslinker EPOCROS WS-500 (trade name, supplied by Nippon Shokubai Co., Ltd.) and yielded a pressure-sensitive adhesive composition. Next, the composition was applied onto a Japanese paper substrate (having a thickness of 73±5 μm and a density of 0.59 g/cm³) to form a pressure-sensitive adhesive composition layer. Next, the pressure-sensitive adhesive composition layer on the Japanese paper substrate was dried and underwent a crosslinking reaction to form a 25-μm thick pressure-sensitive adhesive layer. This process was performed by heating at a temperature of 130° C. for 5 minutes. The pressure-sensitive adhesive sheet for build stage use (single-sided pressure-sensitive adhesive sheet) according to Example 1 was prepared by a procedure as above.

### Example 2

A pressure-sensitive adhesive composition was prepared by combing 100 parts by mass of the acrylic polymer solution P1 with 0.7 part by mass of a water-soluble oxazoline crosslinker EPOCROS WS-500 (trade name, supplied by Nippon Shokubai Co., Ltd.). Next, the composition was applied onto a Japanese paper substrate (having a thickness of 70±5 μm and a density of 0.59 g/cm³) to form a pressure-sensitive adhesive composition layer. Next, the pressure-sensitive adhesive composition layer on the Japanese paper substrate was dried and underwent a crosslinking reaction to form a 25-μm thick pressure-sensitive adhesive layer. This process was performed by heating at a temperature of 130° C. for 5 minutes. The pressure-sensitive adhesive sheet for build stage use (single-sided pressure-sensitive adhesive sheet) according to Example 2 was prepared by a procedure as above.

### Example 3

A pressure-sensitive adhesive sheet for build stage use according to Example 3 was prepared by a procedure as follows. Specifically, initially, a mixture was stirred for one hour in a reactor equipped with a reflux condenser, a nitrogen gas inlet tube, a stirrer, and a thermometer while introducing nitrogen gas into the reactor, where the mixture contained 90 parts by mass of n-butyl acrylate (BA), 5 parts by mass of methyl methacrylate (MMA), 5 parts by mass of acrylic acid (AA), and 186 parts by mass of polymerization solvent ethyl acetate. Next, after removing oxygen from the polymerization system by the above procedure, the solution in the reactor was reacted at 63° C. for 10 hours. The solution was then cooled and yielded a solution (acrylic polymer solution P2) containing an acrylic polymer which is a copolymer of BA, MMA, and AA. The acrylic polymer solution P2 had a solids concentration of 35 mass percent.

Next, two plies of a pressure-sensitive adhesive layer with a release liner were formed. In the formation of each release-liner-borne pressure-sensitive adhesive layer, initially, the acrylic polymer solution P2 was combined with, per 100 parts by mass of solids matter contained in the composition, 0.02 part by mass of a tetrafunctional epoxy crosslinker TETRAD C (trade name, supplied by MITSUBISHI GAS CHEMICAL COMPANY, INC.) and 40 parts by mass of a polymerized rosin ester PENSEL D-135 (trade name, supplied by Arakawa Chemical Industries, Ltd.) and yielded a pressure-sensitive adhesive composition. Next, the composition was applied onto a surface-release-treated 38-μm thick poly(ethylene terephthalate) film (release liner) to form a pressure-sensitive adhesive composition layer. Next, the pressure-sensitive adhesive composition layer on the release liner was dried and underwent a crosslinking reaction to form a 65-μm thick pressure-sensitive adhesive layer. This process was performed by heating at a temperature of 100° C. for 3 minutes. Thus, two plies of a pressure-sensitive adhesive layer (having a thickness of 65 μm) with release liner were formed.

In the preparation of the pressure-sensitive adhesive sheet for build stage use according to Example 3, next, the exposed adhesive face of one of the release-liner-borne pressure-sensitive adhesive layers obtained by the above procedure was adhered onto one side of a nonwoven fabric substrate (having a thickness of 75±6 m and a density of 0.30 g/cm³) made from 100% hemp pulp, and the exposed adhesive face of the other release-liner-borne pressure-sensitive adhesive layer was adhered onto the other side of the nonwoven fabric substrate. Next, the resulting laminate was aged at 50° C. for 48 hours. Thus, the pressure-sensitive adhesive sheet for build stage use (double-sided pressure-sensitive adhesive sheet) according to Example 3 was prepared by a procedure as above.

### Example 4

A pressure-sensitive adhesive sheet for build stage use according to Example 4 was prepared by a procedure as follows. Specifically, initially, a crepe paper substrate (having a thickness of 125 μm and a density of 0.51 g/cm³) was subjected to a sizing agent treatment by applying a sizing agent containing a poly(vinyl acetate) emulsion to both sides of the substrate and drying the applied sizing agent. The amount of solids deposited on the substrate by the treatment was 10 g/m². Next, a backing agent PEELOIL 1010 (trade name, supplied by Ipposha Oil Industries, Co., Ltd.) was applied onto one side (back side) of the crepe paper substrate and dried. Next, a pressure-sensitive adhesive composition was prepared by dissolving, in toluene, 100 parts by mass of a natural rubber (RSS 1 Grade), 50 parts by mass of a terpene resin YS RESIN PX1150N (trade name, supplied by Yasuhara Chemical Co., Ltd.) as a tackifier, 10 parts by mass of an alkylphenol resin TACKROL 201 (trade name, supplied by Taoka Chemical Co., Ltd.), and 2 parts by mass of an age inhibitor Noclac NS-5 (trade name, supplied by OUCHI SHINKO CHEMICAL INDUSTRIAL CO., LTD.); and the pressure-sensitive adhesive composition was applied to an opposite side of the above-prepared crepe paper substrate to the back side (backing agent-coated side) and dried at room temperature. This gave a 40-μm thick rubber pressure-sensitive adhesive layer on the crepe paper substrate. Thus, the pressure-sensitive adhesive sheet for build stage use (single-sided pressure-sensitive adhesive sheet) according to Example 4 was prepared by a procedure as above.

### Comparative Example 1

A pressure-sensitive adhesive sheet according to Comparative Example 1 was prepared by a procedure as follows. Specifically, initially, a Japanese paper substrate (having a thickness of 60 μm and a density of 0.48 g/cm³) was subjected to a sizing agent treatment by applying a sizing agent containing a poly(vinyl acetate) emulsion to both sides of the substrate and drying the applied sizing agent. The amount of solids deposited on the substrate by the treatment was 8 g/m². Next, a backing agent PEELOIL 1010 (trade name, supplied by Ipposha Oil Industries, Co., Ltd.) was applied onto one side (back side) of the Japanese paper substrate, and the applied backing agent was dried. Next, a pressure-sensitive adhesive composition was prepared by dissolving, in toluene, 100 parts by mass of natural rubber (RSS 1 Grade), 50 parts by mass of a tackifier Quintone F-100 (trade name, supplied by ZEON CORPORATION), 15 parts by mass of a softener Diana Process Oil PW-300, (trade name supplied by Idemitsu Kosan Co., Ltd.), and 2 parts by mass of an age inhibitor Noclac NS-5 (trade name, supplied by OUCHI SHINKO CHEMICAL INDUSTRIAL CO., LTD.), and the resulting pressure-sensitive adhesive composition was applied to an opposite side of the Japanese paper substrate, which had been prepared by a procedure as above, to the back side (backing agent-coated side), and the applied composition was dried at room temperature. This gave a 30-μm thick rubber pressure-sensitive adhesive layer on the Japanese paper substrate. Thus, the pressure-sensitive adhesive sheet (single-sided pressure-sensitive adhesive sheet) according to Comparative Example 1 was prepared by a procedure as above.

### Comparative Example 2

A double-sided pressure-sensitive adhesive sheet (having a thickness of each pressure-sensitive adhesive layer of 65 μm) according to Comparative Example 2 was prepared by a procedure similar to that in Example 3, except for using another nonwoven fabric substrate instead of the nonwoven fabric substrate made from 100% hemp pulp. The other nonwoven fabric had a thickness of 45 μm and a density of 0.32 g/cm³ and was made from, as its composition, 40 mass percent of hemp pulp, 38 mass percent of wood pulp, 19 mass percent of rayon fibers, and 3 mass percent of poly(vinyl alcohol) fibers.

Puncture Strength

The pressure-sensitive adhesive sheets according to the examples and the comparative examples were each evaluated for puncture strength using a puncture strength tester (needle piercing strength tester) KES-G5 (trade name, supplied by KATO TECH CO., LTD.). Specifically, a sample piece as a measuring target was cut from each pressure-sensitive adhesive sheet, and a probe having a hemispherical head with the radius of curvature of 0.5 mm was allowed to pierce the sample piece at a travel speed of 0.2 mm/s; and a maximum load during the piercing process was measured. A jig used in the measurement was a jig that holds the measuring target while leaving a round aperture (having a diameter of 11 mm) exposed at both sides of the target. The measurement was performed at a temperature of 23° C., in which, while the measuring target was held by the jig, the probe was allowed to pierce the central portion of the round aperture by the procedure as described above. The measurement was repeated a total of 20 times per pressure-sensitive adhesive sheet, and the average of values resulting from the 20 measurements was defined as the puncture strength (N) of the pressure-sensitive adhesive sheet. The results are given in Table 1.

Fracture Energy and Tensile Strain at Break

The pressure-sensitive adhesive sheets according to the examples and the comparative examples were each evaluated for fracture energy and tensile strain at break, using a tensile break tester (universal tensile tester) Autograph AG-20 kNG (trade name, supplied by Shimadzu Corporation). Specifically, a sample piece (18 mm wide) as a test target was cut from each pressure-sensitive adhesive sheet, both ends of which were secured to a pair of chucks (disposed at a distance in the tensile direction) in the tester, and subjected to a tensile break test at an initial gripping distance of 125 mm and a tensile speed of 300 mm/min. The measurement was performed at a temperature of 23° C. The fracture energy (E), which is energy necessary to cause rupture of the sample piece, can be determined according to Expression (1), in which integration is performed in the range from the deformation amount of the sample piece at the start of the measurement (x=0) to the deformation amount of the sample piece at break (at rupture), where the deformation amounts are determined in the tensile direction. The tensile strain at break is a proportion or ratio of the deformation amount or elongated length in the tensile direction of the sample piece at break to the initial length of the sample piece at the start of the measurement, where the lengths are determined in the tensile direction. A total of three tensile break tests was performed for each pressure-sensitive adhesive sheet, and averages of fracture energy values and tensile strain at break values resulting from the three measurements were defined respectively as the fracture energy (N·m) and the tensile strain at break (%) of the pressure-sensitive adhesive sheet. The results are given in Table 1.

90-Degree Peel Strengths

The pressure-sensitive adhesive sheets according to the examples and the comparative examples were evaluated for 90-degree peel strengths by procedures as follows.

First 90-Degree Peel Strength from Acrylic Plane

Initially, a sample piece (18 mm wide by 100 mm long) to be subjected to adhesive strength (peel strength) measurement was cut from a sample pressure-sensitive adhesive sheet, and was laminated onto an acrylic plate SHINKOLITE (trade name, supplied by Mitsubishi Rayon Co., Ltd.) by a compression bonding operation of one reciprocating movement of a 2-kg roller. Next, the resulting article was left stand in a room temperature environment for 30 minutes, and the 90-degree peel strength of the sample piece from the acrylic plate was then measured using a peel tester TENSILON Type Peel Tester TMC-1 kNB (trade name, supplied by TAMSUI CORPORATION). The measurement was performed at a measurement temperature or a peel temperature of 23° C., a sample piece width of 18 mm as described above, a peel angle of 90 degrees, and a tensile speed of 300 mm/min. The peel test was performed a total of three times, and the average of values resulting from the three measurements was defined as the first 90-degree peel strength (N/18 mm) of the pressure-sensitive adhesive sheet from the acrylic plate or acrylic plane. The results obtained by the technique as above (technique M) are given in Table 1.

First 90-Degree Peel Strength from Aluminum Plane

The first 90-degree peel strength from an aluminum plane was determined by a technique similar to the technique M, except for using, as an adherend instead of the acrylic plate, an aluminum plate SK-A Aluminum Plate (trade name, supplied by Sumitomo Light Metal Industries, Ltd.). The results are given in Table 1.

First 90-Degree Peel Strength from Polyimide Plane

The first 90-degree peel strength from a polyimide plane was determined by a technique similar to the technique M, except for using, as an adherend instead of the acrylic plate, an aluminum plate bearing a single-sided pressure-sensitive adhesive polyimide sheet No. 360UL (trade name, supplied by Nitto Denko Corporation) laminated on a surface thereof; and laminating the sample piece onto the back side (polyimide plane) of the polyimide sheet.

Second 90-Degree Peel Strength from Aluminum Plane

The second 90-degree peel strength from an aluminum plane was determined by a technique similar to the technique M, except for using, as an adherend instead of the acrylic plate, an aluminum plate SK-A Aluminum Plate (trade name, supplied by Sumitomo Light Metal Industries, Ltd.) and subjecting the sample piece after lamination onto the adherend to a heat treatment at 100° C. for 24 hours and subsequent cooling down. The results are given in Table 1.

Second 90-Degree Peel Strength from Polyimide Plane

The second 90-degree peel strength from a polyimide plane was determined by a technique similar to the technique M, except for using, as an adherend instead of the acrylic plate, an aluminum plate bearing a single-sided pressure-sensitive adhesive polyimide sheet No. 360UL (trade name, supplied by Nitto Denko Corporation) laminated on a surface thereof; laminating the sample piece onto the back side (polyimide plane) of the polyimide sheet; and subjecting the sample piece after lamination onto the adherend to a heat treatment at 100° C. for 24 hours and subsequent cooling down. The results are given in Table 1.

Evaluation for Removability from Build Stage

The pressure-sensitive adhesive sheets according to the examples and the comparative examples were evaluated for removability from a build stage. Specifically, initially, a sample pressure-sensitive adhesive sheet was laminated onto an object-forming surface of a build stage of an additive manufacturing apparatus, fused filament fabrication 3D printer BS01+(trade name, supplied by BONSAI LAB, Inc.). Next, the apparatus (3D printer) was brought into operation to concurrently form six objects on the pressure-sensitive adhesive sheet disposed on the build stage. The additive manufacturing was performed using, as a modeling material (build material), a polylactic acid filament PolyPlus (trade name, natural color type, supplied by Polymaker) having a cross-sectional diameter of 1.75 mm. The object forming process was performed at a temperature of the build stage of 50° C. and a heating temperature of the modeling material of 220° C. in a nozzle that discharges and supplies the modeling material onto the build stage. The objects were each a flat sheet having a length of 50 mm, a width of 10 mm, and a thickness of 2 mm. The objects were formed on the back side (substrate) in the case of the single-sided pressure-sensitive adhesive sheets (Examples 1, 2, and 4 and Comparative Example 1); and were formed on one of the adhesive faces in the case of the double-sided pressure-sensitive adhesive sheets (Example 3 and Comparative Example 2). After the temperature of the formed objects fell down to room temperature, a removing operation of the pressure-sensitive adhesive sheet from the build stage was performed. The removing operation was performed by pulling the pressure-sensitive adhesive sheet within such a range that the angle formed by the build stage plane and the pressure-sensitive adhesive sheet fell in the range of 450 to 850. In the removing operation as above, a sample with which the objects could be detached from the build stage by removing the pressure-sensitive adhesive sheet from the build stage without breakage of the pressure-sensitive adhesive sheet was evaluated as being very good (VG); a sample with which the objects could be detached from the build stage by removing the pressure-sensitive adhesive sheet from the build stage, although the pressure-sensitive adhesive sheet was partially broken, was evaluated as being good (Good); and a sample that underwent excessive breakage of the pressure-sensitive adhesive sheet and required the use of a scraper to detach the objects from the build stage was evaluated as being poor (Poor). The results are given in Table 1.

Evaluation

The pressure-sensitive adhesive sheets for build stage use according to Examples 1 to 4, which have the configurations according to the present invention, enabled appropriate detachment of the objects from the build stage by the removing operation of the pressure-sensitive adhesive sheet from the build stage. In contrast, the pressure-sensitive adhesive sheets according to Comparative Examples 1 and 2 failed to provide appropriate detachment of the objects from the build stage when the removing operation of the pressure-sensitive adhesive sheet from the build stage was performed alone.

TABLE 1

| | | | | | Comparative | Comparative |
|---|---|---|---|---|---|---|
| | Example 1 | Example 2 | Example 3 | Example 4 | Example 1 | Example 2 |
| Puncture strength (N) | 4.37 | 4.08 | 5.39 | 4.72 | 3.16 | 2.00 |
| Fracture energy (N · m) | 0.51 | 0.28 | 2.22 | 0.84 | 0.22 | 0.05 |
| Tensile strain at break (%) | 6.78 | 5.44 | 30.23 | 12.68 | 3.66 | 3.73 |
| First 90-degree peel strength from acryl (N/18 mm) | 2.92 | 2.35 | 11.43 | 3.38 | 2.37 | 9.13 |
| First 90-degree peel strength from aluminum (N/18 mm) | 1.81 | 1.49 | 10.30 | 2.84 | 1.81 | 8.87 |
| First 90-degree peel strength from polyimide (N/18 mm) | 2.00 | 1.55 | 10.10 | 2.69 | 1.82 | 8.07 |
| Second 90-degree peel strength from aluminum (N/18 mm) | 1.44 | 1.18 | 20.57 | 3.48 | 7.86 | — |
| Second 90-degree peel strength from polyimide (N/18 mm) | 2.98 | 2.61 | 15.6 | 3.23 | 4.64 | — |
| Removability evaluation | VG | Good | Good | Good | Poor | Poor |

### REFERENCE SIGNS LIST

X1, X2 pressure-sensitive adhesive sheet (pressure-sensitive adhesive sheet for build stage use)
11 substrate
12 pressure-sensitive adhesive layer
13 pressure-sensitive adhesive layer
S build stage
Sa object-forming surface
W object

1. A pressure-sensitive adhesive sheet for build stage use, the pressure-sensitive adhesive sheet having a multilayer structure comprising:
a substrate; and
a pressure-sensitive adhesive layer,
the pressure-sensitive adhesive sheet having a puncture strength of 3.3 to 12 N, where the puncture strength is determined as a maximum load during a process in which a probe having a hemispherical head with radius of curvature of 0.5 mm pierces the pressure-sensitive adhesive sheet at a travel speed of 0.2 mm/s.

2. A pressure-sensitive adhesive sheet for build stage use, the pressure-sensitive adhesive sheet having a multilayer structure comprising:
a first pressure-sensitive adhesive layer;
a second pressure-sensitive adhesive layer; and
a substrate disposed between the first and second pressure-sensitive adhesive layers,
the pressure-sensitive adhesive sheet having a puncture strength of 3.3 to 12 N, where the puncture strength is determined as a maximum load during a process in which a probe having a hemispherical head with radius of curvature of 0.5 mm pierces the pressure-sensitive adhesive sheet at a travel speed of 0.2 mm/s.

3. The pressure-sensitive adhesive sheet for build stage use according to claim 1,
wherein the pressure-sensitive adhesive sheet has a fracture energy of 0.24 to 4 N·m, where the fracture energy is energy necessary to cause rupture of the pressure-sensitive adhesive sheet in a tensile break test performed at a sample width of 18 mm, a gripping distance of 125 mm, and a tensile speed of 300 mm/min.

4. The pressure-sensitive adhesive sheet for build stage use according to claim 1,
wherein the pressure-sensitive adhesive sheet has a tensile strain at break of 4% to 50%.

5. The pressure-sensitive adhesive sheet for build stage use according to claim 1,
wherein the pressure-sensitive adhesive sheet has a 90-degree peel strength from an acrylic plane of 0.5 to 15 N/18 mm, where the 90-degree peel strength is measured at a peel temperature of 23° C. and a tensile speed of 300 mm/min.

6. The pressure-sensitive adhesive sheet for build stage use according to claim 1,
wherein the pressure-sensitive adhesive sheet has a 90-degree peel strength from an aluminum plane of 0.5 to 15 N/18 mm, where the 90-degree peel strength is measured at a peel temperature of 23° C. and a tensile speed of 300 mm/min.

7. The pressure-sensitive adhesive sheet for build stage use according to claim 1,
wherein the pressure-sensitive adhesive sheet has a 90-degree peel strength from an aluminum plane of 0.5 to 15 N/18 mm, where the 90-degree peel strength is measured at a peel temperature of 23° C. and a tensile speed of 300 mm/min after the pressure-sensitive adhesive sheet undergoes lamination onto the aluminum plane, subsequent heat treatment at 100° C. for 24 hours, and subsequent cooling down.

8. The pressure-sensitive adhesive sheet for build stage use according to claim 1,
wherein the pressure-sensitive adhesive sheet has a 90-degree peel strength from a polyimide plane of 0.5 to 15 N/18 mm, where the 90-degree peel strength is measured at a peel temperature of 23° C. and a tensile speed of 300 mm/min.

9. The pressure-sensitive adhesive sheet for build stage use according to claim 1,
wherein the pressure-sensitive adhesive sheet has a 90-degree peel strength from a polyimide plane of 0.5 to 15 N/18 mm, where the 90-degree peel strength is measured at a peel temperature of 23° C. and a tensile speed of 300 mm/min after the pressure-sensitive adhesive sheet undergoes lamination onto the polyimide plane, subsequent heat treatment at 100° C. for 24 hours, and subsequent cooling down.

10. The pressure-sensitive adhesive sheet for build stage use according to claim 1,
wherein the substrate comprises a paper substrate.

11. The pressure-sensitive adhesive sheet for build stage use according to claim 10,
wherein the paper substrate comprises at least one selected from the group consisting of:
Japanese paper;
crepe paper;
kraft paper;
glassine paper; and
synthetic paper.

12. The pressure-sensitive adhesive sheet for build stage use according to claim 1,
wherein the substrate comprises a nonwoven fabric substrate.

13. The pressure-sensitive adhesive sheet for build stage use according to claim 12,
wherein the nonwoven fabric substrate comprises at least one selected from the group consisting of:
pulp;
rayon;
acetate fibers;
polyester fibers;
polyamide fibers;
polyolefin fibers; and
poly(vinyl alcohol) fibers.

14. The pressure-sensitive adhesive sheet for build stage use according to claim 13,
wherein the pulp comprises at least one selected from the group consisting of hemp pulp and wood pulp.

15. The pressure-sensitive adhesive sheet for build stage use according to claim 1,
wherein the substrate comprises a plastic substrate.

16. The pressure-sensitive adhesive sheet for build stage use according to claim 15,
wherein the plastic substrate comprises at least one selected from the group consisting of:
a polyolefin film;
a polyester film;
a polyimide resin film;
a polyamide resin film;
a vinyl chloride resin film; and
a vinyl acetate resin film.

17. The pressure-sensitive adhesive sheet for build stage use according to claim 1,
wherein the pressure-sensitive adhesive layer comprises one selected from:
an acrylic pressure-sensitive adhesive;
a rubber pressure-sensitive adhesive; and
a silicone pressure-sensitive adhesive.

18. The pressure-sensitive adhesive sheet for build stage use according to claim 17,
wherein the acrylic pressure-sensitive adhesive comprises an acrylic polymer including 50 mass percent or more of a monomer unit derived from an alkyl (meth)acrylate.

19. The pressure-sensitive adhesive sheet for build stage use according to claim 18,
wherein the alkyl (meth)acrylate comprises at least one selected from the group consisting of:
n-butyl acrylate;
2-ethylhexyl acrylate; and
methyl methacrylate.

20. The pressure-sensitive adhesive sheet for build stage use according to claim 17 for build stage,
wherein the rubber pressure-sensitive adhesive comprises at least one selected from the group consisting of:
natural rubbers; and
synthetic rubbers.
